(19) United States
(12) Patent Application Publication
(10) Pub. No.: US 2003/0103351 A1
(43) Pub. Date: Jun. 5, 2003

(54) Multiple image display apparatus for works of art and photographs

(76) Inventors: Yves E. Privas, Sea Ranch Lakes, FL (US); Tanguy Manuarii Privas, Sea Ranch Lakes, FL (US)

Correspondence Address: Oltman, Flynn & Kubler, 415 Galleria Professional Building, 915 Middle River Drive, Ft. Lauderdale, FL, 33304, US

(21) Appl. No.: 10/314,760

(22) Filed: Dec. 9, 2002

Related U.S. Application Data
(63) Continuation-in-part of application No. 09/644,574, filed on Aug. 24, 2000.
(63) Continuation-in-part of application No. 09/390,577, filed on Sep. 3, 1999, now Pat. No. 6,390,648.

(51) Int. Cl. F21V 1/00

(52) U.S. Cl. 362/276

(57) ABSTRACT

An apparatus for alternatingly displaying several two-dimensional images, the apparatus including an image sheet printed with a series of discrete elongate segments of the several two-dimensional images, these image segments being mutually parallel and laterally spaced apart in a repeating sequence comprising a segment of a first image, and then a segment of a second image and then a segment of a third image; a light source behind the image sheet oriented to cast light through the image sheet; a lenticular lens including a flat sheet of transparent material having a lens surface embossed with an array of mutually parallel linear bulges corresponding in width and lateral spacing with image segment widths and lateral spacing; and a frame housing retaining the image sheet and the lens in front of and substantially parallel with the image sheet, so that movement of an observer standing generally in front of the lens relative to the apparatus causes all and only image segments of the first image to become visible through the lens so that the first image appears substantially complete, and then causes all and only image segments of the second image to become visible through the lens so that the second image appears substantially complete, and then causes all and only image segments of the third image to become visible through the lens so that the third image appears substantially complete. The lens is preferably laterally moved relative to the image sheet by a lens reciprocating mechanism against spring biasing so that the images appear in sequence.

### FILING HISTORY

This application is a continuation-in-part of application Ser. No. 09/644,574 filed on Aug. 24, 2000, and of application Ser. No. 09/390,577 filed on Sep. 3, 1999.

### BACKGROUND OF THE INVENTION

1. Field of the Invention

The present invention relates generally to the field of display structures for two-dimensional or three-dimensional art works, photographs or any other type of graphic. More specifically the present invention relates to an apparatus for alternatingly displaying several distinct and separate images, such as for advertising purposes which may be entirely different from each other or may be a progressive sequence of the same image producing simulated image motion. The apparatus preferably includes a lenticular image sheet printed with a series of discrete elongate segments of the several two-dimensional images, and a diffusion semi-translucent back panel behind the image sheet and a light source behind the back panel oriented to cast light through the image sheet. The image segments are mutually parallel and laterally spaced apart in a repeating sequence comprising a segment of a first image, and then a segment of a second image and then a segment of a third image. The apparatus further includes a lenticular lens in the form of a flat sheet of transparent material having a lens surface embossed with an array of mutually parallel concave or convex linear lens bulges corresponding in width and lateral spacing with image segment widths and lateral spacing; and a frame housing retaining the image sheet and the lens in front of and substantially parallel with the image sheet. Whether the image is two-dimensional or three-dimensional depends on the orientation of the lens. For each of several viewing perspectives, the image segments for each given image exclusively combine or interface with each other through the lenticular lens to present each given image to the observer.

For a first embodiment, upright lens retaining means engage edges of the lens and thereby retain the lens, upright image sheet guide means behind and substantially parallel to the lens slidably retain the image sheet, a light source behind the image sheet directs light through the image sheet and lens, and image sheet reciprocating means periodically move the image sheet upwardly and permit gravity to alternately lower the image sheet so that the image sheet reciprocates relative to the lens. The lens and image are oriented such that the lenticular dividing lines extend horizontally, so that upward and downward movement of the image sheet relative to the lens causes the image shift.

The frame preferably has two upright and laterally spaced apart elongate frame side portions and an elongate frame bottom portion, and the lens preferably is a rectangular sheet. The frame side portions and preferably the frame bottom portion as well include a forward peripheral slot opening toward the center of the frame into which edges of the rectangular lens are fitted, and a middle peripheral guide flange also opening toward the center of the frame which edges of the image sheet slidably ride against, and a rearward peripheral slot for engaging the light source. More specifically the frame preferably includes integral forward and rearward channels having a common channel side wall and opening toward the center of the frame to define the forward and rearward peripheral slots, and a jog in the common channel side wall defines the middle peripheral guide flange. The frame bottom and side portions also each include a frame structural channel which extends from the forward channel web forwardly. The frame structural channel preferably also extends between the upper ends of the frame side portions to define a frame top portion. The structural channel preferably turns inward at a right angle toward the center of the frame and then turns rearwardly to provide an attractive frame border for the lens and image and to add structural strength to the frame.

The light source preferably is a light box having a light box rear wall, four light box side walls joined to and extending forwardly from the light box rear wall, the light box side walls having an outward peripheral light box mounting flange with a forwardly facing panel retaining lip within which is mounted a frosted, translucent support panel. The light source is contained within the light box. The light box also contains a battery power source such as a battery, or has a power cord connectable to an external power source, and contains a light source electric circuit preferably including a circuit board connecting the power source to the light source and to the motor. A battery or cord outlet power source The light box side walls preferably tilt toward each other rearwardly so that the light box is generally dish shaped. The light box removably mounts to the rear of the frame by sliding the light box mounting flange into the rearward peripheral slot. The light box preferably is either fastened to a wall or includes a channel shaped light box base into which the light box lower end removably fits which positions the light box substantially upright, with a rearward tilt to display the image to persons passing by the apparatus.

The image sheet reciprocating means preferably includes an electric motor mounted within the light box and having a motor drive shaft extending forwardly through a motor port in the support panel and through a notch in the image sheet lower edge. A ball bearing is mounted around the motor drive shaft forward end and the image sheet bears against the ball bearing so that vertical reciprocation of the shaft forward end but none of the rotation of the shaft forward end is transmitted to the image sheet. The ball bearing abuts the image sheet edge and remains rotationally fixed relative to the image sheet, while the motor drive shaft rotates within the ball bearing.

For a second embodiment, the movement of an observer standing generally in front of the lens relative to the apparatus causes all and only image segments of the first image to become visible through the lens so that the first image appears substantially complete, and then causes all and only image segments of the second image to become visible through the lens so that the second image appears substantially complete, and then causes all and only image segments of the third image to become visible through the lens so that the third image appears substantially complete. The three images are merely exemplary, and presentation of more than three images or of just two images is contemplated. The lens is preferably mounted within the frame housing to be laterally movable relative to the image sheet and is laterally moved by an image sheet reciprocating mechanism against the biasing of an opposing spring so that the images appear in sequence to a stationary observer. The lens is moved horizontally so that the shifting position of the observer as he or she walks by the apparatus does not cancel or alter the shift of the image from his or her perspective.

2. Description of the Prior Art

There have long been frame support structures for displaying advertising photographs. There also have long been easels and wall mounted frames adjacent to incandescent light sources receiving power from electric cords plugging into wall sockets, for displaying and illuminating art works. Examples of prior art image lighting products are PICTURE LIGHTS™ and PICTURE-LITE™ of New World Lighting, Inc. A problem with these display means has been that they present only a single, static image, which is easily missed or ignored by passersby. Another problem has been that the cords supplying power to the light sources are unsightly and detract from the display. Yet since power is needed to light the images continuously throughout the day, the use of battery power sources is impractical because they would so frequently require replacing.

It is thus an object of the present invention to provide an apparatus for mounting and displaying with rear illumination multiple two-dimensional images in a single frame, in which the images shift from one to the next so that only one image is displayed at a time to an observer, thereby attracting and holding the attention of the observer.

It is another object of the present invention to provide such an apparatus which includes a motion or heat sensor and switch combination in the power circuit to detect the approach of a potential viewer and thereupon close the switch to deliver power to the light source and illuminate the images as the person approaches.

It is still another object of the present invention to provide such an apparatus which includes a timer within the motion sensor and switch combination to open the switch after a pre-set length of time following the last detected movement, so that electric power is conserved to make batteries a practical power source and so that the attention of a potential viewer is drawn to the image as he or she approaches the apparatus and image. This object in practical terms requires use of the rapid illumination light source mentioned in one of the previous objects, because a conventionally wide fluorescent bulb might not light at all before the timer duration elapsed and turned off power to the bulb.

It is a still further object of the invention to provide an apparatus for displaying two-dimensional images having the general appearance of a frame and having an add-on outer border and an add-on inner border to provide the option of altering the appearance of the display.

It is a still further object of the present invention to provide such an apparatus which can illuminate photographs and prints of paintings with full pigment intensity, avoiding a color washout, and which can also radiate greater light intensity at selected locations on the photographs, such as where one would expect bright areas in the photograph images.

It is finally an object of the present invention to provide such an apparatus which is relatively inexpensive to manufacture and is attractive in appearance.

### SUMMARY OF THE INVENTION

The present invention accomplishes the above-stated objectives, as well as others, as may be determined by a fair reading and interpretation of the entire specification.

An apparatus is provided for sequentially displaying several distinct and separate two-dimensional images, including a lenticular image sheet printed with a series of discrete elongate image segments of at least two images, the image segments being mutually parallel and laterally spaced apart in a repeating sequence including a segment of a first image, and then a segment of a second image; a translucent back panel behind the image sheet; a light source oriented to cast light through the back panel; a power source connected to the light source through a power circuit; a lenticular lens including a sheet of transparent material having a lens surface embossed with an array of mutually parallel linear lens bulges corresponding in width and lateral spacing with the width and lateral spacing of the image segments; and a frame housing retaining the image sheet and the lens in front of and substantially parallel with the image sheet, the frame housing having an open forward region through which the image sheet is visible through the lens; so that the image segments for each given image exclusively combine with each other through the lenticular lens to present exclusively each given image to an observer in front of the frame housing.

The apparatus preferably additionally includes a mechanism for causing relative movement between the lens and the image sheet. The apparatus preferably additionally includes a lens retaining structure slidably retaining the lens within the frame housing. The apparatus preferably still additionally includes an lens reciprocating mechanism mounted to slide the lens within the lens retaining structure so that the images appear in sequence to a stationary observer. The apparatus preferably further includes a reciprocation biasing spring mounted against the lens opposite the lens reciprocating mechanism for returning the lens after the lens is moved by the reciprocating mechanism. The lens preferably is moved horizontally by the lens reciprocating mechanism so that shifting positions of a moving observer do not cancel the change of image visible to the observer.

The lens retaining structure preferably includes several guide screws extending rearwardly through ports in the forward panel and in the back panel, the guide screws being positioned relative to the back panel so that two first guide screws substantially define a line along which an edge of the lens is placed and a second guide screw is spaced from the line a distance corresponding to the width of the lens, so that the lens fits slidably between the first guide screws and the second the guide screw. The back panel preferably is substantially rectangular, and the guide screws are located at each corner of the lens and the lens is substantially rectangular, so that two opposing and parallel rectilinear lens edges ride along the first and second guide screws, respectively, as the lens slides within the lens retaining structure. The apparatus preferably additionally includes a forward panel fitted over the forward face of the lens, having forward panel ports fitting over the first and second guide screws, and the guide screws are threaded at their rearward ends and fit engagingly into threaded ports in the back panel, to hold the back panel, the lens and the forward panel together. The apparatus preferably additionally includes a spring between the back panel and the forward panel to create a desired minimal amount of force against the forward panel to keep the forward panel in contact with the lens.

The frame housing preferably is a substantially dish-shaped frame panel oriented substantially vertically, the frame panel having a substantially rectangular perimeter panel border to present the visual impression of a frame, a picture abutment region of the frame panel immediately within the panel border and extending toward the center of the frame panel and recessed rearwardly, and a central depression defining a battery compartment encompassed by the abutment region, where the backboard, image sheet, and lens are fitted and removably secured within the panel border abutting the abutment region.

The apparatus preferably additionally includes an outer conversion border for fitting over and around the panel border, the outer conversion border including a rectangular or otherwise shaped elongate member configured as a loop having the general shape of the frame panel perimeter, the outer conversion border having a forward molding, an integral receiving perimeter flange extending rearwardly from and along the forward molding, and being spaced radially outwardly from the forward molding inner edge to create a frame housing receiving step along the forward molding; so that the frame panel fits closely within the receiving step and is contained by the perimeter flange; and tabs for obstructing the frame panel from sliding out of the perimeter flange. The apparatus preferably still additionally includes an inner conversion border including a looped elongate member shaped and sized in perimeter to fit snugly within the frame panel, over the lens and over the image sheet.

The apparatus preferably further includes terminal wiring, a PC board and a battery charger and a battery charger outlet, where the electric power source includes a battery connected to the terminal wiring and to the PC board, the PC board being contained within the battery compartment, and the wiring being connected to the battery charger outlet and the battery charger outlet being mounted in a port in the frame panel to face outwardly from the frame panel; and a battery charger having structure for plugging into the battery charger outlet and for plugging into a building wall outlet.

The light source preferably includes a bulb notch in an edge of the back panel, a fluorescent light bulb fitted within the bulb notch, so that the fluorescent light bulb casts light into and through the back panel and forwardly through the image sheet. The apparatus preferably additionally includes a motion sensor mounted to the frame housing and directed to sense motion generally forwardly of the apparatus, the motion sensor being integrated into the power circuit so that the light source is activated only when movement is sensed. The apparatus preferably additionally includes a timer circuit element incorporated into the power circuit for shutting off power to the light source after a certain amount of time has passed since the motion sensor last detected motion. The apparatus preferably further includes a table top stand including a block having a mounting notch in its upper surface for removably receiving an edge of the frame panel to hold the frame panel upright.

### BRIEF DESCRIPTION OF THE DRAWINGS

Various other objects, advantages, and features of the invention will become apparent to those skilled in the art from the following discussion taken in conjunction with the following drawings, in which:

FIG. 1 is an exploded view of the apparatus, showing the image sheet positioned and aligned for insertion into the frame, and light box positioned and aligned for insertion into the frame.

FIG. 2 is a partial cross-sectional side view of the apparatus showing the preferred sheet reciprocating mechanism.

FIG. 3 is a cross-sectional side view of the entire apparatus, showing the reciprocating mechanism and showing the image sheet and image sheet panel extended partly from the frame.

FIG. 4 is a front view of the apparatus, showing the lenticular lens and surrounding frame.

FIG. 5 is a side view of the apparatus lower end fitted into the preferred apparatus supporting and positioning base.

FIG. 6 is an exploded side view of the lens, reinforcement sheet and adhesive, and FIG. 6a is an assembled side view.

FIG. 7 is a schematic wiring diagram of the alternating current motor speed control.

FIG. 8 is a schematic wiring diagram of the fluorescent light dimmer.

FIG. 9 is an exploded perspective view of the preferred embodiment, showing the various elements making up the apparatus image structure, with the frame housing omitted.

FIG. 9a is a broken away end view of the back panel showing the preferred light bulb receiving notch and bulb positioned for insertion into the notch.

FIG. 10 is an upper perspective view of the assembled image structure of FIG. 9.

FIG. 11 is an upper perspective view of the frame housing, showing the battery compartment and a battery, and the PC board and battery charger.

FIG. 12 is a cross-sectional side view of the frame panel, the light source and an optional mat cover M positioned to fit over the image structure within the frame panel border.

FIG. 13 is a side view of a generally C-shaped clip which preferably fits over the notched edge of the back plate to help hold the bulb within the notch.

FIG. 14 is a perspective view of the table top stand.

FIG. 15 is a front view of the alternative version of the frame panel.

FIG. 16 is an end view of the frame panel of FIG. 15.

FIG. 17 is a rear perspective view of the outer conversion border, showing the bendable tabs.

FIG. 18 is a forward perspective view of the conversion border positioned to fit around the frame housing.

FIG. 19 is a view as in FIG. 18, of the inner conversion border positioned to fit within the frame housing.

FIG. 20 is a forward perspective view of the completely assembled apparatus, having the inner conversion border but excluding the outer conversion border.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### Preferred Embodiments

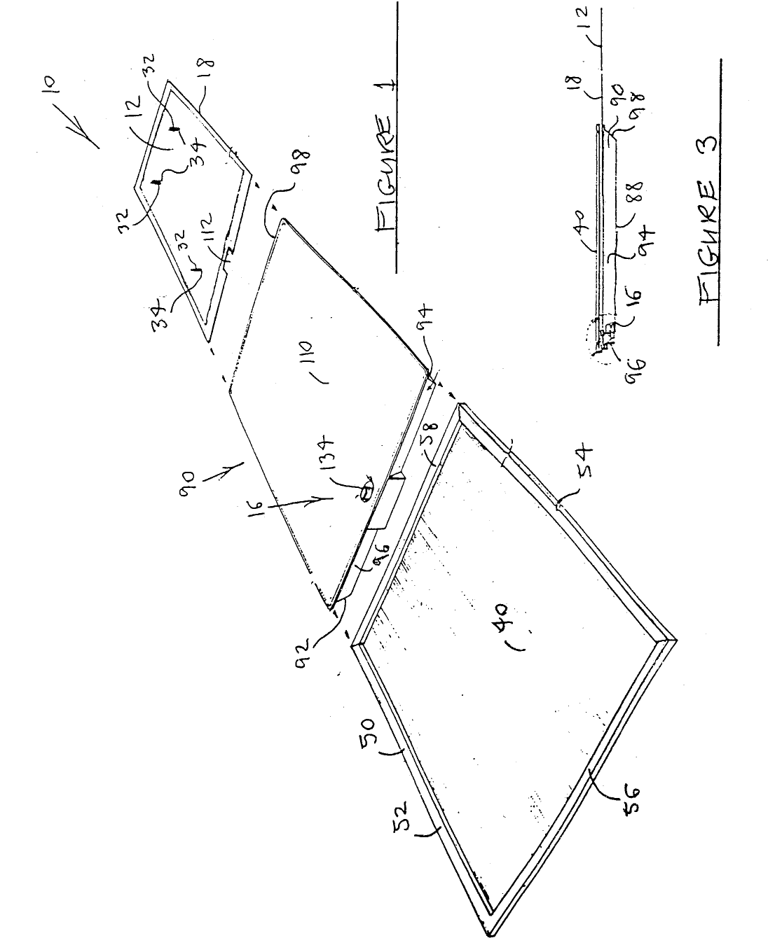

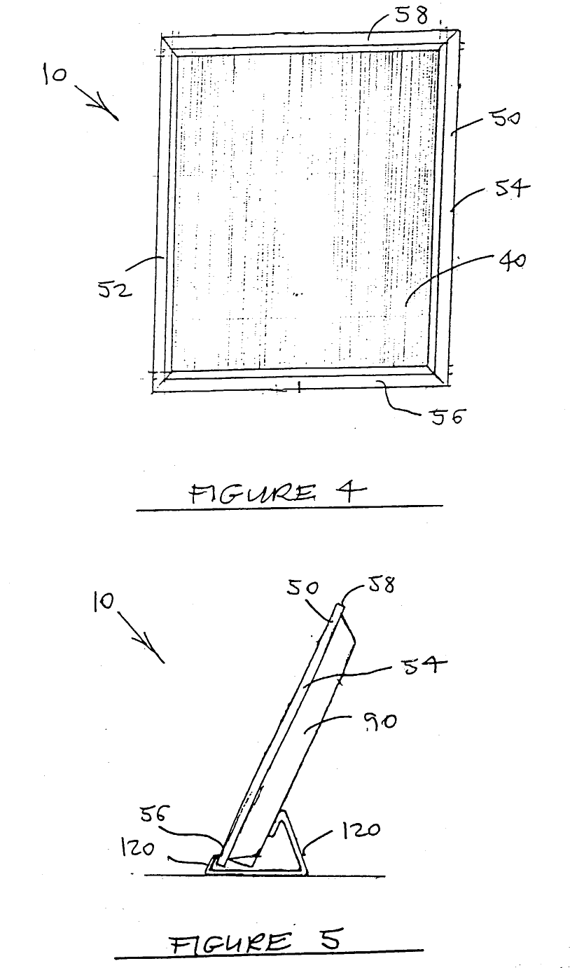

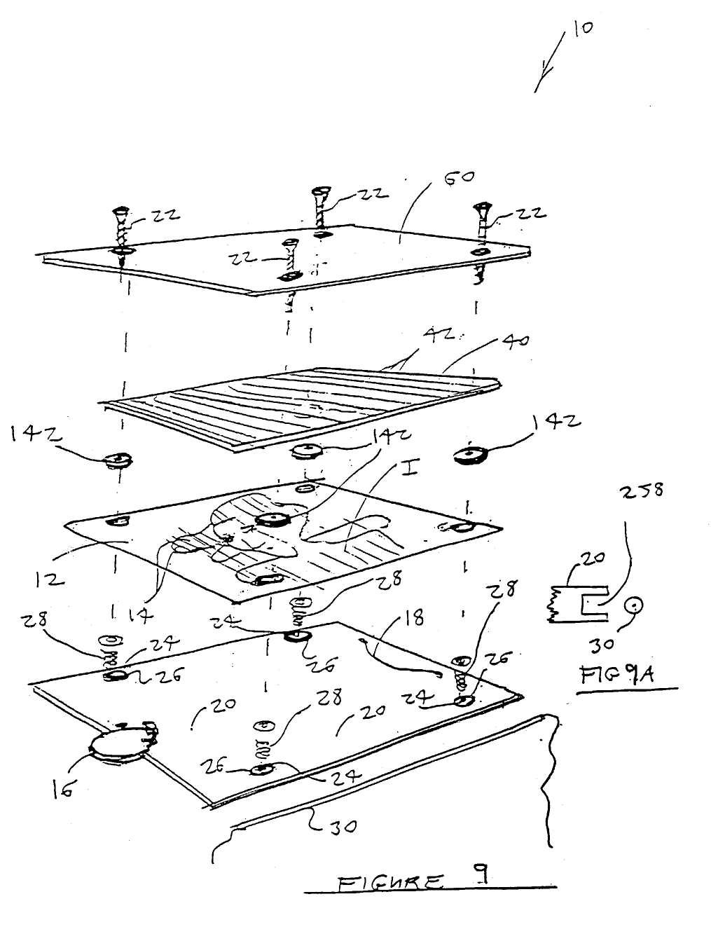

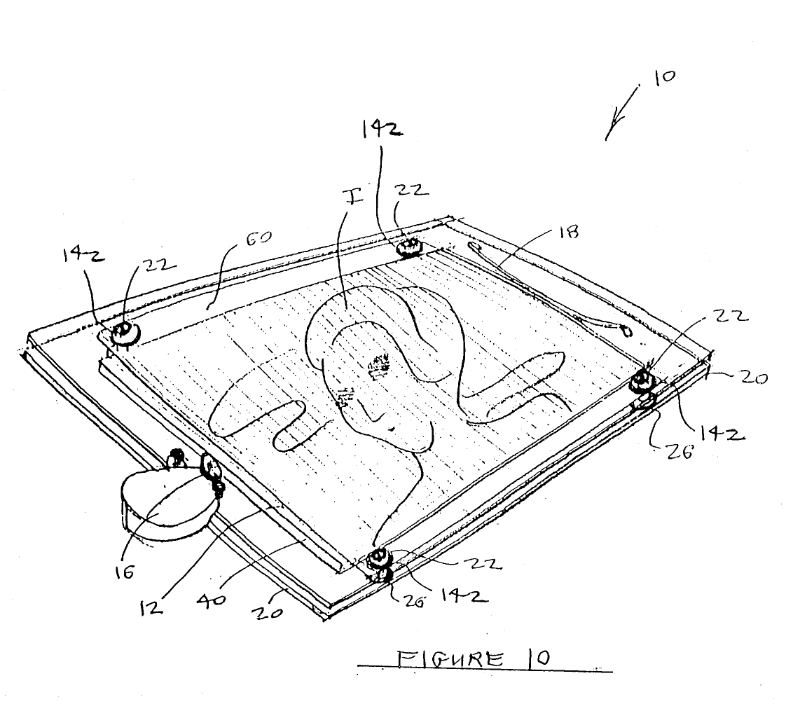

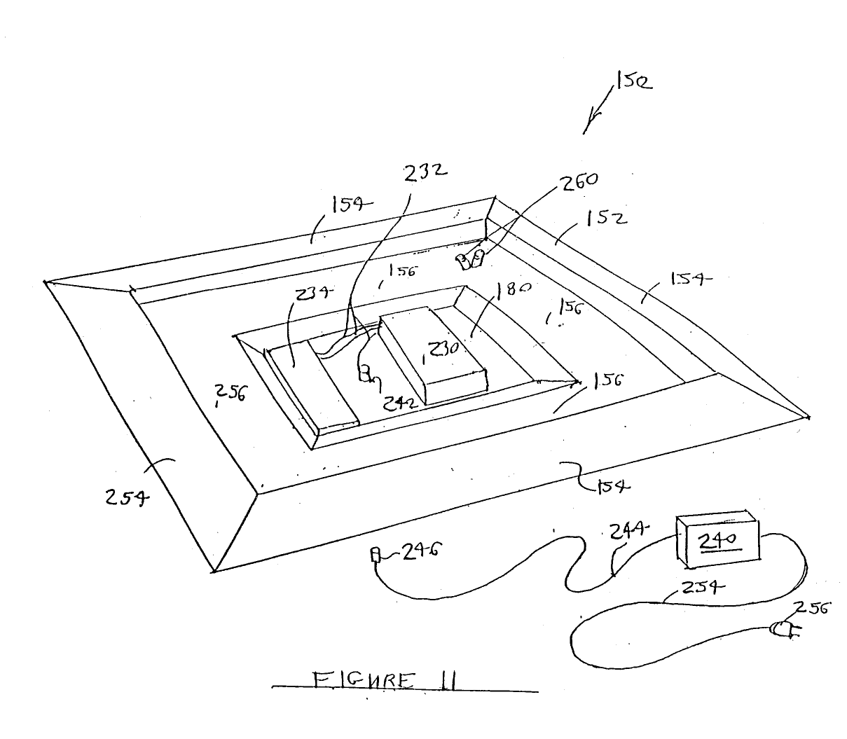

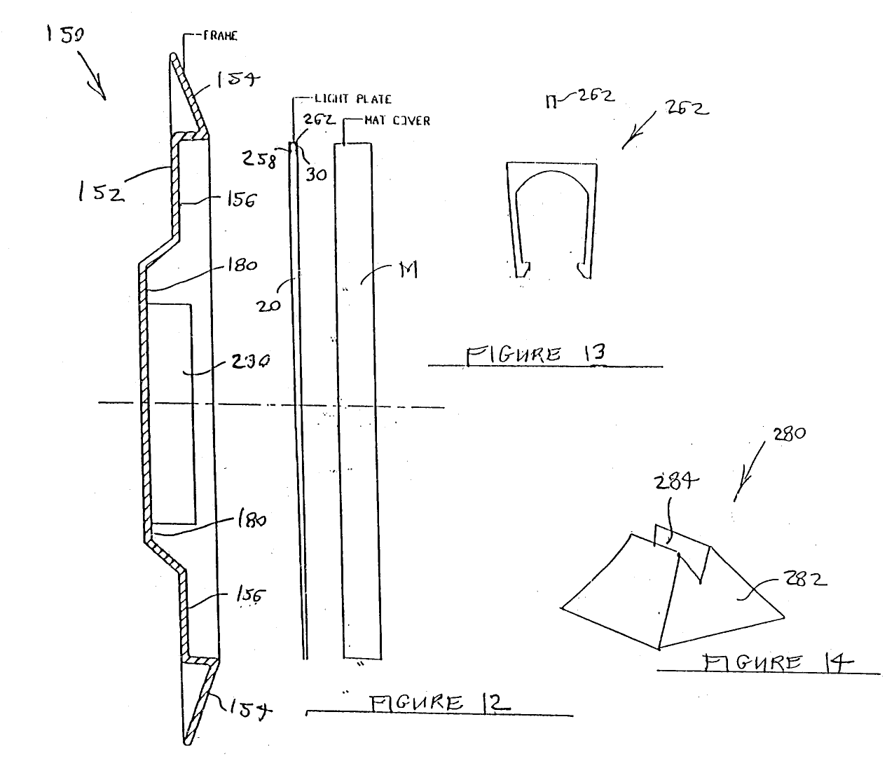

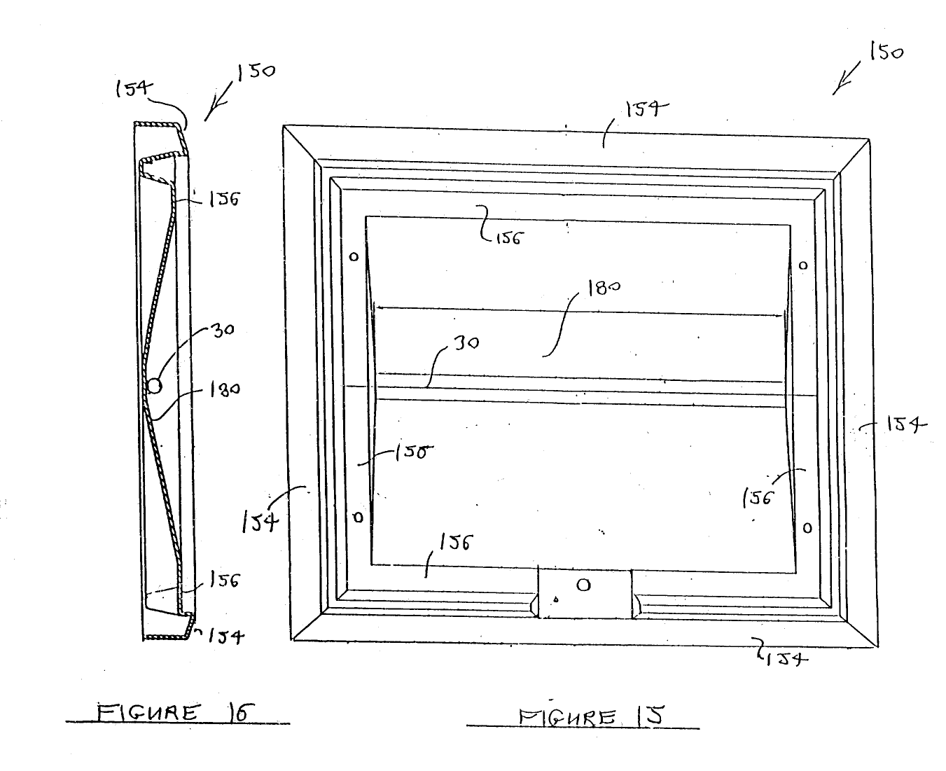

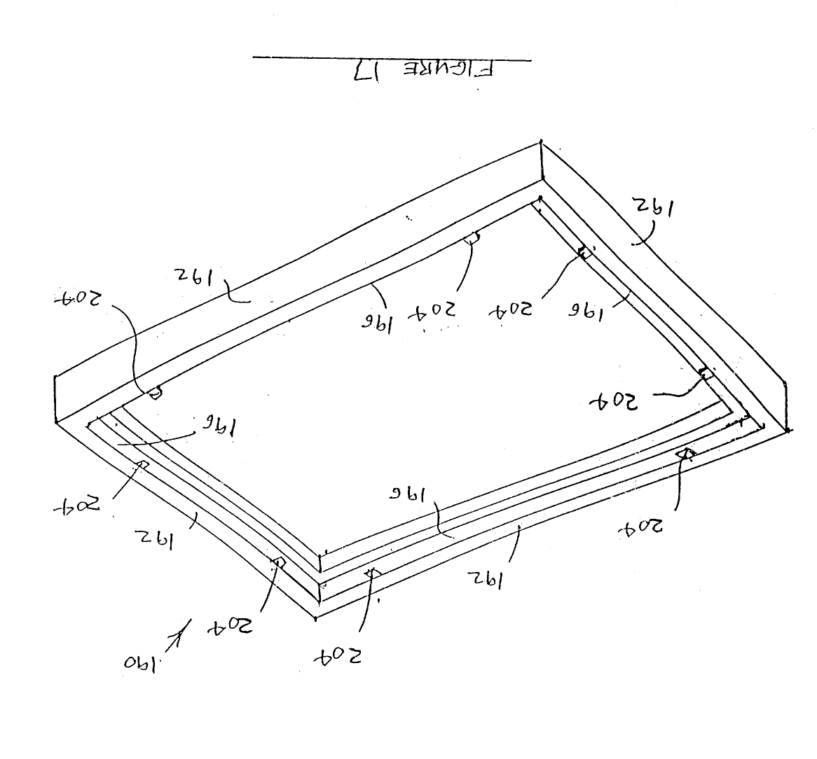

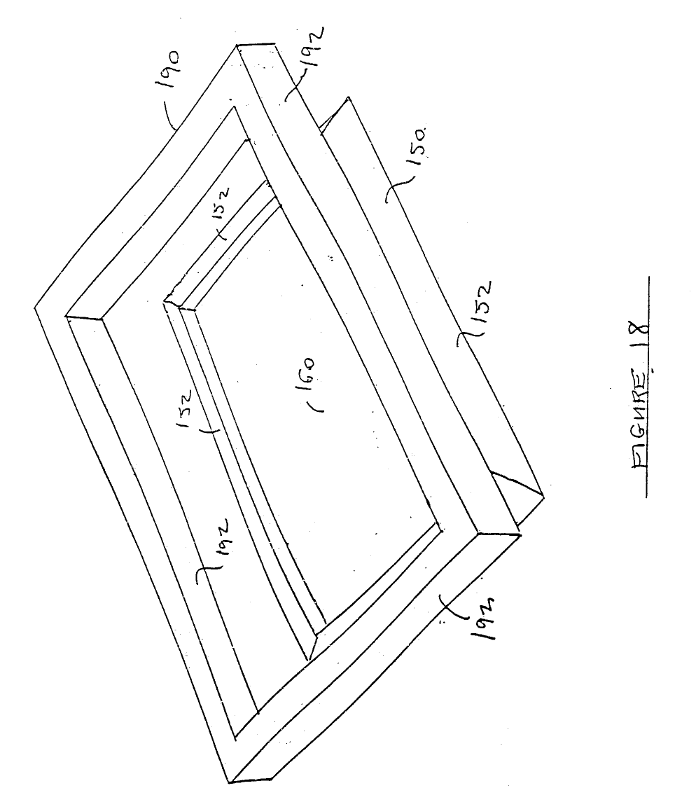

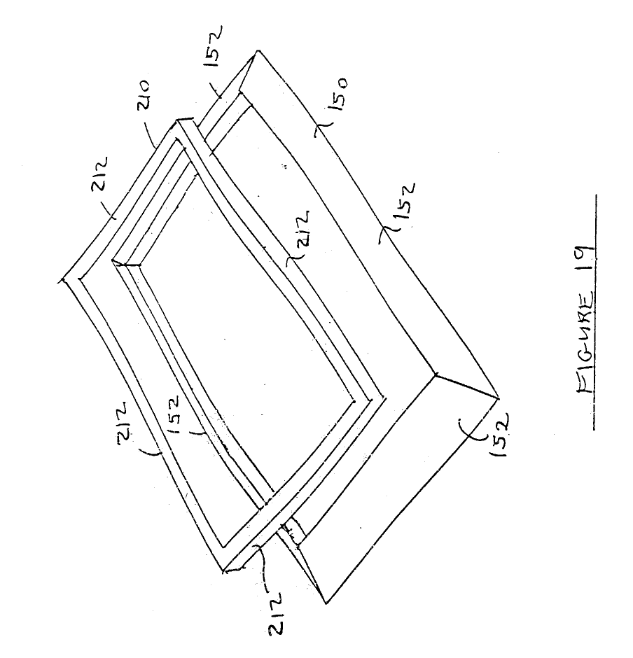

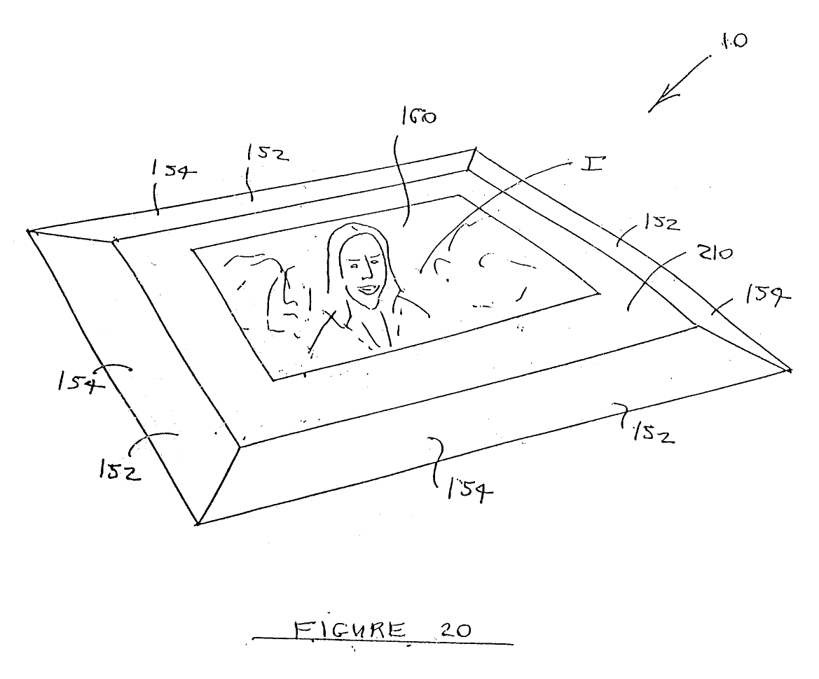

Referring to FIGS. 1-20, an apparatus 10 for alternatingly displaying several distinct and separate two-dimensional images is disclosed, such as for advertising purposes. Apparatus 10 includes a lenticular image sheet 12 printed with a series of discrete elongate image segments 14 of the several two-dimensional images, and a translucent back panel 20 behind image sheet 12 and a light source 30 laterally adjacent to or behind back panel 20 oriented to cast light through image sheet 12. The image segments 14 are mutually parallel and laterally spaced apart in a repeating sequence comprising a segment 14 of a first image, and then a segment 14 of a second image and then a segment 14 of a third image. Apparatus 10 further includes an optical barrier in the form of a lenticular lens 40 configured as a flat sheet of transparent material having a lens surface S embossed with an array of mutually parallel linear lens bulges 42 corresponding in width and lateral spacing with image segment 14 widths and lateral spacing; and a frame 50 retaining the image sheet 12 and the lens 40 in front of and substantially parallel with the image sheet 12. The lens bulges 42 are contiguous concave and convex prisms which show and hide the intended areas of the graphic image sheet 12. From each of several viewing perspectives, which may be created by movement of the image sheet 12 relative to the lens 40 such a with a motor, the image segments 14 for each given image exclusively combine or interlace with each other through the lenticular lens 40 to present each given image to the observer.

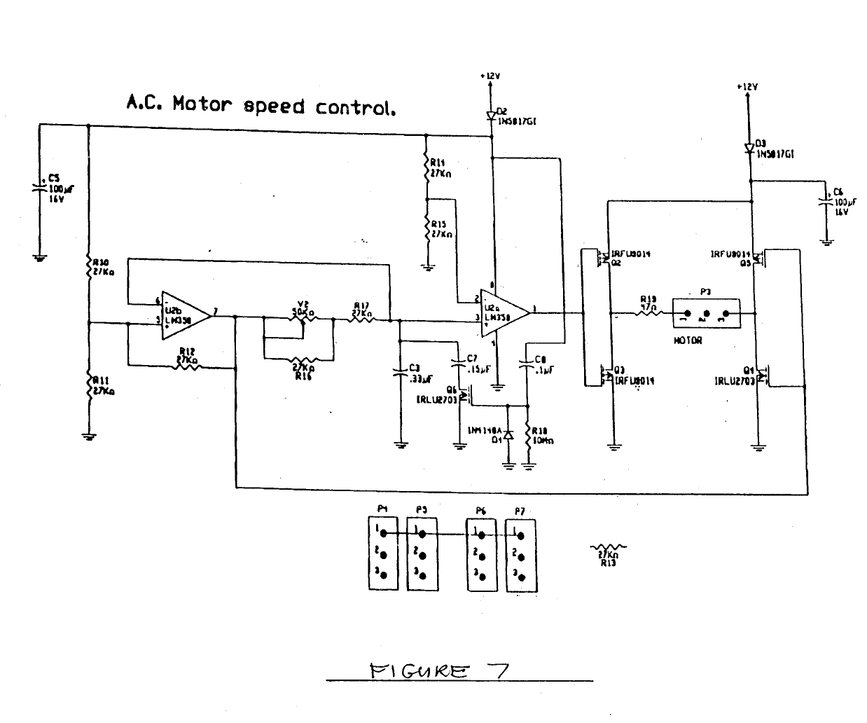

The more lens bulges 42 per inch, the thinner the lens 40 has to be, because the focal length of the individual bulges 42 is shorter and the focal length must terminate at the face of the lens 40 opposite the face having the bulges 42. As the lens 40 becomes thinner, it looses rigidity and may not remain fully planar during apparatus 10 operation and flexing relative to the image sheet 12 can cause a loss of focus called “ghosting” of images. Therefore the lens 40 and image sheet panel 18 preferably are formed of rigid, resilient material, so that they remain in very close, uniform, flush proximity or mutual surface contact. Yet in instances in which the lens 40 is too thin for the use of resilient lens 40 material to solve the problem, it is preferred that a sufficiently thick clear acrylic reinforcement sheet 44 be laminated onto the lens bulge 42 face of the lens 40. See FIG. 6. This lamination preferably is accomplished by applying a clear double sided adhesive 46 to the contact face of the acrylic reinforcement sheet 44 so that no air bubbles are created. Then the face of the lens 40 having the bulges 42 is pressed against and secured to the contact face of the acrylic reinforcement sheet 44 using a cold laminator. This causes the adhesive 46 to attach only to the protruding crests of the bulges 42.

### First Preferred Embodiment

For a first embodiment, upright lens retaining means LR engage edges of the lens 40 and thereby retain the lens 40, upright image sheet guide means ISG behind and substantially parallel to the lens 40 slidably retain the image sheet 12, a light source 30 behind the image sheet 12 directs light through the image sheet 12 and lens 40, and image sheet reciprocating means 16 periodically move the image sheet 12 upwardly and permit gravity to alternately lower the image sheet 12 so that the image sheet 12 reciprocates relative to the lens 40. See FIGS. 1-8. Either the image sheet 12 is mounted to an image sheet panel 18 preferably with at least three pins 32 extending from the image sheet panel 18 through corresponding holes 34 in the image sheet. The pins 32 preferably have distinctive cross-sections other than round, such as U-shaped, and the corresponding holes 34 into which the pins 32 fit have matching shapes to receive the pins 32, or distinctive locations. These unique pin 32 shapes and locations cause the pins 32 to act as keys so that the apparatus 10 accepts only image sheets 12 manufactured by the same company that made the apparatus 10. For purposes of the claims the term image sheet panel refers to either of these arrangements. Three perforations are made on image sheet panel 18 which serve as a guide to a matching perforated graphic. The three pins 32 are then inserted through the registering plate 18 and perforated graphic image sheet 12 to secure the graphic image sheet 12 from internal movement that may compromise visualization quality of the intended image areas to be shown. As a result, the graphic image sheet 12 is simply dropped into the apparatus 10, and no lamination is needed. The lens 40 and image are oriented such that the image segments 14 extend horizontally, and upward and downward movement of the image sheet 12 relative to the lens 40 causes the shift from one displayed image to the next.

The frame 50 preferably has two upright and laterally spaced apart elongate frame side portions 52 and 54 and an elongate frame bottom portion 56, and the lens 40 preferably is a rectangular or square sheet. The frame side portions 52 and 54 and preferably the frame bottom portion 56 as well include a forward peripheral slot 72 which opens toward the center of the frame 50 into which edges of the rectangular lens 40 are fitted, and a middle peripheral guide flange 74 also extending toward the center of the frame 50 which edges of the image sheet panel 18 slidably ride against, and a rearward peripheral slot 76 for engaging the light source 30. More specifically the frame 50 preferably includes integral forward and rearward channels 82 and 86, respectively, having a common channel side wall 84 and opening toward the center of the frame 50 to define the forward and rearward peripheral slots 72 and 76, and a jog in the common channel side wall 84 defines the middle peripheral guide flange 78. The frame bottom and side portions 56 and 52 and 54, respectively, also each include a frame structural channel 80 which extends from the forward channel 82 web forwardly. The frame structural channel 80 preferably also extends between the upper ends of the frame side portions 52 and 54 to define a frame top portion 58. The-structural channel 80 preferably turns inward at a right angle toward the center of the frame 50 and then turns rearwardly to provide an attractive frame border for the lens 40 and displayed images and to add structural strength to frame 50.

The light source 30 preferably is contained within a light box 90 having a light box rear wall portion 88, two light box side wall portions 92 and 94 and light box bottom and top wall portions 96 and 98, respectively, joined to and extending forwardly from the light box rear wall portion 88, the light box side wall portions 92 and 94 and light box bottom and top wall portions 96 and 98 having an outward peripheral light box mounting flange 102 with a forwardly facing panel retaining lip 104 within which is mounted a frosted, translucent support panel 110. The light source 30 is contained within the light box 90 and preferably is a cold cathode fluorescent bulb. The fluorescent bulb most always be oriented perpendicular to the orientation of the lens bulges 42. The light box 90 also contains a battery power source 128 such as a lead battery, or has a power cord connectable to an external power source, and contains a light source electric circuit preferably including a circuit board 138 connecting the power source to the light source 30 and to the image sheet reciprocating means 16. The light box side wall portions 92 and 94 and light box bottom and top wall portions 96 and 98 preferably tilt toward each other rearwardly so that the light box 90 is generally dish shaped. The light box 90 removably mounts to the rear of the frame 50 by sliding the light box mounting flange 102 into the rearward peripheral slot 76. Alternatively, the light box mounting flange 102 and the rearward peripheral slot 76 may be omitted and the frame 50 molded together with and as an integral part of the light box, and in this instance is preferably molded from a suitable plastic. The light box 90 preferably is either fastened to a wall or includes a channel shaped light box base 120 into which the light box 90 lower end removably fits which positions the light box 90 substantially upright, with a rearward tilt to display the images to persons passing by the apparatus 10.

The image sheet panel 18 reciprocating means 16 preferably includes an electric motor 130 mounted within the light box 90 and having a motor drive shaft 132 extending forwardly through a motor port 136 in the support panel 110 and through a notch 112 in the image sheet panel 18 lower edge. A ball bearing 134 is mounted eccentrically around the motor drive shaft 132 forward end to function as a cam and the image sheet panel 18 bears against the ball bearing 134 so that vertical reciprocation of the shaft 132 forward end, but none of the rotation of the shaft 132 forward end, is transmitted to the image sheet panel 18. The ball bearing 134 abuts the image sheet panel 18 edge and remains rotationally fixed relative to the image sheet panel 18, while the motor drive shaft 132 rotates within the ball bearing 134, to minimize and virtually eliminate friction. Only image sheet panel 18 is moved.

The versatility of the apparatus 10 of the first embodiment resides in its various functions to adapt to multiple lighting conditions. Power to the light source 30 preferably is adjustable, so that the intensity of back lighting of the images can be altered and selected. The apparatus 10 visibly displays the images on the image sheet 12 when the light source 30 is lighted to full brightness, to partial brightness or when the light source 30 is not activated at all and there is no back light. The motor 130 speed can be adjusted as well, to ensure proper or adequate display of the sequence of images.

### Second Preferred Embodiment

For a second embodiment, the lens 40 and image sheet 12 dividing lines are oriented vertically so that movement of an observer standing generally in front of the lens 40 relative to the apparatus 10 causes all and only image segments 14 of the first image to become visible through the lens 40 so that the first image appears substantially complete, and then causes all and only image segments 14 of the second image to become visible through the lens 40 so that the second image appears substantially complete, and then causes all and only image segments 14 of the third image to become visible through the lens 40 so that the third image appears substantially complete. The description of three images is merely exemplary, and presentation of more than three images or of just two images is contemplated. The image sheet 12 displayed can be a photograph as described below, a transparency, a frame of film, or a drawing on paper.

Where three-dimensional images are desired, vertical orientation of the lens bulges 42 is required because the interlace image is based on the principle of binocular disparity, wherein the eyes of the viewer each receive a different perspective and which is interpreted as depth. For the viewer to perceive three-dimensional images, a parallax must be created, and for this to happen the lens bulges 42 must be vertical. No parallax is perceived by the human eye if they are horizontal.

The lens 40 is preferably mounted within a frame housing 150 to be laterally movable relative to the image sheet 12 and is laterally moved by an image sheet reciprocating mechanism 16 against the biasing of an opposing spring 18, preferably in the form of a leaf spring, so that the images appear in sequence to a stationary observer. It is alternatively contemplated that the image sheet 12 be moved relative to the lens 40, such as by reciprocating mechanism 16 and spring 18. The lens 40 is moved horizontally so that the shifting position of the observer as he or she walks by the apparatus 10 does not cancel or alter the of the image from his or her perspective.

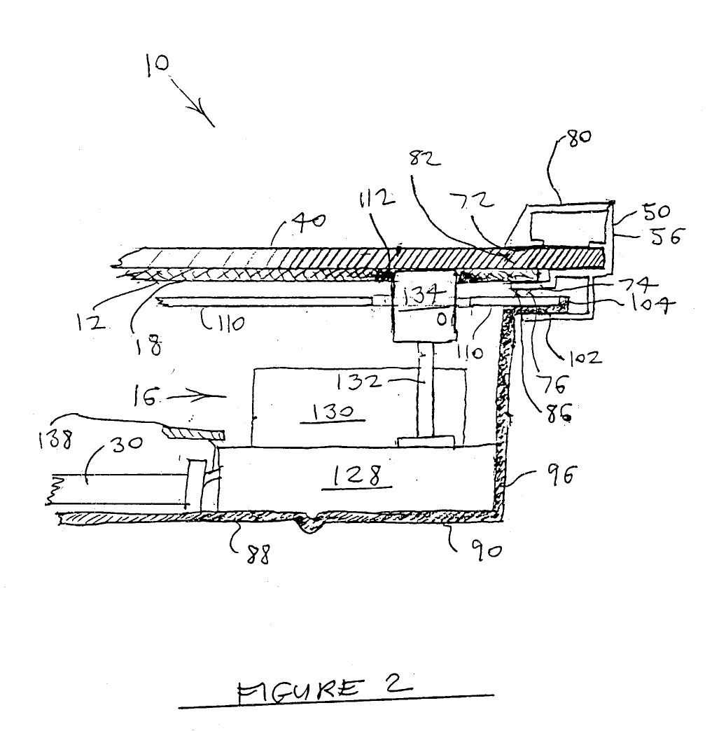

At least three, and preferably four, guide screws 22 fits through ports in forward panel 160 and through ports in the image sheet 12 and back panel 20. Guide wheels 142 fit around guide screws 22 to roll against edges of lens 40 to minimize friction resistance to lens 40 movement. Guide screws 22 are positioned relative to back panel 20 so that two first guide screws 22 fitted with guide wheels 142 define a line along which a rectilinear edge of the lens 40 is placed and one or more second guide screws 22 fitted with guide wheels 142 are spaced from this line a distance corresponding to the width of the lens 40. See FIGS. 1 and 2. Lens 40 fits slidably between the first guide screws 22 and their encircling guide wheels 142 and the second guide screw 22 and the encircling guide wheel 142.

The back panel 20 preferably is rectangular, and guide screws 22 and guide wheels 142 are preferably at each corner of the rectangle. The lens 40 is also preferably rectangular, so that two opposing and parallel rectilinear lens 40 edges ride on guide wheels 142 fitted around the first and second guide screws 22, respectively, as lens 40 slides. A forward panel 160 is preferably fitted over the forward surface S of the lens 40, having forward panel ports 162 which fit around the first and second guide screws 22. Guide screws 22 are preferably threaded at their rearward ends and fit into threaded back panel ports 24 and washers 26 preferably fit engagingly onto guide screws 22 to hold the back panel 20, lens 40 and forward panel 160 together. The guide screws 22 are secured loosely enough that friction between the lens 40 and forward panel 160 is minimal and permits sliding of the lens 40 between the image sheet 12 and forward panel 160 with minimal resistance. A coil spring 28 is optionally placed between washers 26 and forward panel 160 to create just a desired minimal amount of force against the forward panel 160 to keep forward panel 160 in contact with lens 40. Alternatively, leaf springs (not shown) may be provided between the lens 40 and forward panel 160 to maintain this desired amount of force. The back panel 20, lens 40, forward panel 160 and guide screws 22 are all preferably made of a durable transparent plastic such as LUCITE™. Many perimeter shapes other than rectangular are contemplated, such as square, oval, circular, hexagonal and triangular, since conventional picture frames are often found in many shapes.

Frame panel 152 preferably has a rectangular perimeter panel border 154 angled radially outwardly and rearwardly to present the impression of a picture frame. A picture abutment region 156 of frame panel 152 immediately within and extending toward the center of frame panel 152 is recessed rearwardly from the front surface of the panel border 154, and a middle region of frame panel 152 encompassed by abutment region 156 is recessed rearwardly still further to create a central depression defining a battery compartment 180. A picture structure such as backboard 20, image sheet 12, and lens 40 described above, is fitted and removably secured within panel border 154 and abuts abutment region 156.

The essential frame housing 150 described above presents a certain avant garde appearance. For those who prefer a more traditional look, an outer conversion border 190 is provided which fits over and around panel border 154 and presents the appearance of a traditional picture frame. Outer conversion border 190 includes a rectangular or otherwise shaped elongate member 192 configured as a loop having the general shape of the frame panel 152 perimeter, and thus being typically rectangular. Outer conversion border 190 has a forward molding 194, the forward surface of which is parallel with the lens 40 or is optionally beveled rearwardly and radially inwardly and forward molding 194 is mitered at its corners. An integral receiving perimeter flange 196 extends rearwardly from and along the forward molding 194, and is spaced radially outwardly from the forward molding 194 inner edge to create a frame housing receiving step 202 along the forward molding 194 rear surface. The frame panel 152 fits closely within the receiving step 202 and is contained by the perimeter flange 196. The perimeter flange 196 is optionally sized along its radially inward surface to make snug perimeter contact with frame panel 152 so that friction removably holds frame panel 152 within perimeter flange 196. Additionally, there are provided bendable tab elements 204 as commonly found on conventional picture frames which are rotated to extend directly behind the frame panel 152 and thus to prevent the frame panel 152 from sliding out of perimeter flange 196.

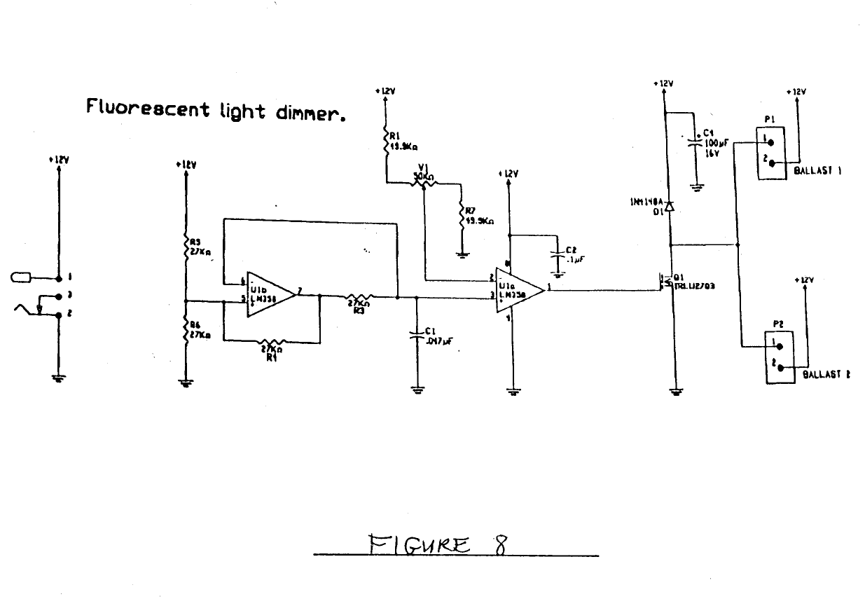

Specifically for the lenticular lens version of the image structure, the frame housing 150 may be a frame panel generally as described above but the battery compartment is tapers linearly from opposing sides in the manner of a wedge to an inverted peak which receives a rear light source 30 in the form a bulb as described herein, containing and mounting the bulb 30 and batteries 130. See FIG. 7. A break is provided along the panel border for receiving the reciprocating mechanism 16.

An inner conversion border 210 is optionally provided which is a looped elongate member 212 shaped and sized in perimeter to fit snugly within the open forward end of frame panel 152, over the lens 40 and over the image sheet 12. Inner conversion border 210 is used where the image is substantially smaller than the lens 40, and serves to bring the frame inner edge closer to the image.

Batteries 230 are provided and are preferably of the rechargeable type and of a substantially planar configuration to fit compactly into battery compartment 180. Batteries 230 are connected to power circuit wiring 232 and thus to a PC board 234 which is contained within the battery compartment 180 and the wiring 232 in turn connects to a charger outlet 236 mounted in a frame panel wiring port 242 to face outwardly and rearwardly. A charger 240 is provided in the form of a box containing a transformer and having a first charger wire 244 extending to frame panel 152 and having a first charger wire plug 246 which removably plugs into a charger outlet 252 wired to circuit wiring 232, and having a second charger wire 254 for extending to a room wall outlet and having a conventional outlet plug 256 at its end for plugging into the room wall outlet. Charger 240 is connected only when batteries 230 become low, which might happen no more than once a month, and charged for several hours to give the batteries 230 a full charge.

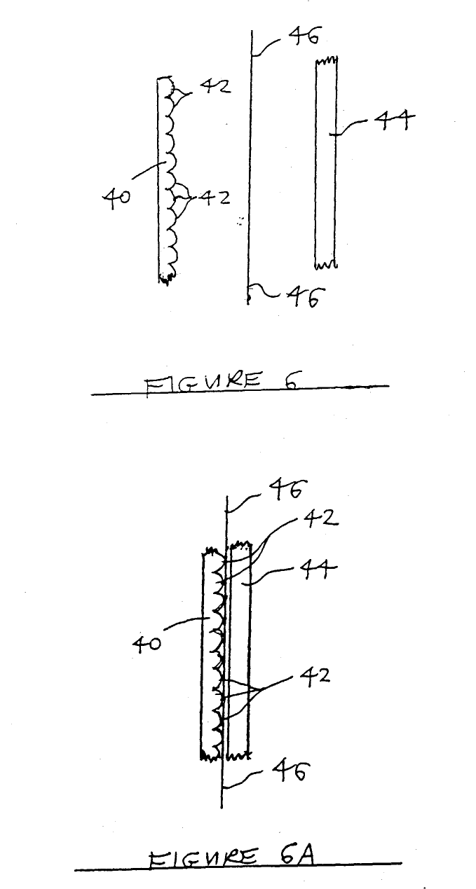

Light source 30 is preferably a very narrow fluorescent light bulb, and is connected by power circuit wiring 232 to the batteries 230 and optionally to a motion sensor 260. Motion sensor 160 is preferably two motion sensors pointing out in diverging directions to widen the range of motion detection. A bulb notch 258 or groove extends along and into an edge of back panel 20, and is preferably secured with a clip 262 as shown in FIG. 5, so that illumination of the bulb 30 casts light into and through back panel 20, and through image sheet 12. The bulb 30 preferably is either part number P/N WL-CFL14115 or P/N WL-CFL14070, by WAMCO, INC™, which are both narrow diameter fluorescent bulbs.

### Third Preferred Embodiment

As indicated above, the picture structure placed into frame panel 152 is optionally of the image shifting type described above. Alternatively, the picture structure is of the general type described in the parent to the present application, including a fixed photograph of a scene or of a painting.

For this second version, photographs are inventively provided with high pigment intensity and have selected brightened areas, for illuminated display. The photographs are composite digital images I, and one is printed on an image sheet 12 outward face and the other is matchingly reversed and aligned printed on the image sheet 12 inward face so that light from light source 30 passes through both, doubling the pigment intensity to look like the original work. Selected areas of the image on the image sheet 12 inward face are omitted or lightened, so that more light passes through these areas, giving them greater brightness than surrounding areas of the composite image I. Alternatively, pigmentation in selected areas is increased relative to the rest of the image, so that less light passes through areas, for darkening areas of a the composite image I which one would expect to appear darker. This selective brightening can create a dramatic effect by brightening candle and sunlight representations in the composite image I. Alternatively, the composite image I photograph may be a conventional photograph with an image on its forward face and a transparent film sheet placed behind the photograph having a reversed image aligned with the photograph image to produce the composite image when light is shined through the photograph and film.

Motion sensor 260 is mounted to the frame housing 150 and directed to sense motion generally forwardly of apparatus 10. Motion sensor 260 is integrated into the battery power circuit wiring 232 so that the light source 30 and reciprocating mechanism 16, if any, are activated only when movement such as of a possible observer is sensed. A timer circuit element (not shown) is also incorporated into the power circuit wiring 232 or motion sensor 268 to shut off power to the light source 30 and reciprocating mechanism 16 after a certain amount of time has passed since motion was last detected, such as perhaps ten seconds.

A table top stand 280 is preferably provided. The stand 280 preferably includes a mounting block 282 of material such as plastic having a mounting notch 284 in its upper surface for removably receiving an edge of the frame panel 152 or outer conversion border. The notch 284 is of sufficient depth and fits closely enough around the edge to hold frame panel 152 upright and oriented to position the frame panel 152 at a desired angle relative to vertical for suitable image display. Frame panel 152 tilts back slightly from horizontal, for example. The mounting block 282 preferably tapers upwardly to have essentially the configuration of a wedge with its tapered end upturned, and the notch 284 may be in or adjacent to the block 282 upper end. All edges of the frame housing 150 and are preferably configured to fit into the mounting block notch 284. Whether mounted in the mounting block 282 or on a building wall, a rectangular frame housing 150 can be oriented so that the frame housing 150 longitudinal axis is horizontal, such as for landscapes, or vertical, such as for portraits.

What is known as a motion barrier is optionally substituted for the lenticular lens 40 and image sheet 12. The motion barrier is static and the image varies with the angle of viewing of the observer.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An apparatus for sequentially displaying several distinct and separate two-dimensional images, comprising:
a lenticular image sheet printed with a series of discrete elongate image segments of at least two images, said image segments being mutually parallel and laterally spaced apart in a repeating sequence comprising a segment of a first said image, and then a segment of a second said image;
a lenticular lens comprising a sheet of transparent material having a lens surface embossed with an array of mutually parallel linear lens bulges corresponding in width and lateral spacing with the width and lateral spacing of said image segments;
upright lens retaining means engaging edges of said lens and thereby retaining said lens;
upright image sheet guide means slidably retaining said image sheet behind and substantially parallel to said lens;
a light source behind the image sheet oriented to direct light through said image sheet and said lens;
and image sheet reciprocating means for periodically moving said image sheet upwardly and permitting gravity to periodically elevate said image sheet such that said image sheet reciprocates relative to said lens;
wherein said lens and said image sheet are oriented relative to each other such that said elongate image segments and said linear lens bulges extend substantially horizontally, such that upward and downward movement of said image sheet relative to said lens replaces one said image with another said image.

2. The apparatus of claim 1, wherein said frame comprises two upright and laterally spaced apart elongate frame side portions and an elongate frame bottom portion interconnecting said frame side portions, and wherein said lens is a substantially rectangular sheet, and wherein said frame side portions comprise a forward peripheral slot opening toward the center of said frame into which edges of said lens are retainingly fitted, and a middle peripheral guide flange opening toward the center of said frame into which edges of said image sheet are retainingly and slidably fitted.

3. The apparatus of claim 2, wherein said frame additionally comprises a rearward peripheral slot for engaging said light source.

4. The apparatus of claim 1, wherein said light source comprises a light box having a light box containing a fluorescent light bulb; a power source and a light source electric circuit connecting said power source to said light source and to said motor.

5. The apparatus of claim 1, wherein said image sheet reciprocating means comprises an electric motor mounted within said light box and having a motor drive shaft with an eccentric motor drive shaft forward end extending forwardly below and adjacent to an edge of said image sheet, a ball bearing mounted around said motor drive shaft forward end, such that said ball bearing abuts the image sheet edge and remains rotationally fixed relative to the image sheet, while the motor drive shaft rotates within the ball bearing and vertical reciprocation of said shaft forward end but none of the rotation of said shaft forward end is transmitted to said image sheet.

6. An apparatus for sequentially displaying several distinct and separate two-dimensional images, comprising:
a lenticular image sheet printed with a series of discrete elongate image segments of at least two images, said image segments being mutually parallel and laterally spaced apart in a repeating sequence comprising a segment of a first said image, and then a segment of a second said image;
a translucent back panel behind said image sheet;
a light source oriented to cast light through said back panel;
a power source connected to said light source through a power circuit;
a lenticular lens comprising a sheet of transparent material having a lens surface embossed with an array of mutually parallel linear lens bulges corresponding in width and lateral spacing with the width and lateral spacing of said image segments;
and a frame housing retaining said image sheet and said lens in front of and substantially parallel with said image sheet, said frame housing having an open forward region through which said image sheet is visible through said lens;
such that said image segments for each given said image exclusively combine with each other through said lenticular lens to present exclusively each given image to an observer in front of said frame housing.

7. The apparatus of claim 6, additionally comprising means for causing relative movement between said lens and said image sheet.

8. The apparatus of claim 6, additionally comprising lens retaining means slidably retaining said lens within said frame housing.

9. The apparatus of claim 8, additionally comprising an lens reciprocating mechanism mounted to slide said lens within said lens retaining means such that the images appear in sequence to a stationary observer.

10. The apparatus of claim 9, additionally comprising a reciprocation biasing spring mounted against said lens opposite said lens reciprocating mechanism for returning said lens after said lens is moved by said reciprocating mechanism.

11. The apparatus of claim 8, wherein said lens is moved horizontally by said lens reciprocating mechanism such that shifting positions of a moving observer do not cancel the change of image visible to the observer.

12. The apparatus of claim 6, wherein said lens retaining means comprises a plurality of guide screws extending rearwardly through ports in said forward panel and in said back panel, said guide screws being positioned relative to said back panel such that two first guide screws substantially define a line along which an edge of said lens is placed and a second guide screw is spaced from the line a distance corresponding to the width of said lens, such that said lens fits slidably between the first said guide screws and the second said guide screw.

13. The apparatus of claim 12, wherein said back panel is substantially rectangular, and said guide screws are located at each corner of said lens and wherein said lens is substantially rectangular, such that two opposing and parallel rectilinear lens edges ride along the first and second said guide screws, respectively, as said lens slides within said lens retaining means.

14. The apparatus of claim 13, additionally comprising a forward panel fitted over the forward face of said lens, having forward panel ports fitting over the first and second said guide screws, and wherein said guide screws are threaded at their rearward ends and fit engagingly onto threaded ports in said back panel, to hold said back panel, said lens and said forward panel together.

15. The apparatus of claim 14, additionally comprising spring means between said back panel and said forward panel to create a desired minimal amount of force against said forward panel.

16. The apparatus of claim 6, wherein said frame housing is a substantially dish-shaped frame panel oriented substantially vertically, said frame panel having a substantially rectangular perimeter panel border to present the visual impression of a frame, a picture abutment region of said frame panel immediately within said panel border and extending toward the center of said frame panel and recessed rearwardly, and a central depression defining a battery compartment encompassed by said abutment region, wherein said backboard, image sheet, and lens are fitted and removably secured within said panel border abutting said abutment region.

17. The apparatus of claim 16, additionally comprising an outer conversion border for fitting over and around said panel border, said outer conversion border comprising a rectangular or otherwise shaped elongate member configured as a loop having the general shape of said frame panel perimeter, said outer conversion border having a forward molding, an integral receiving perimeter flange extending rearwardly from and along said forward molding, and being spaced radially outwardly from said forward molding inner edge to create a frame housing receiving step along said forward molding; such that said frame panel fits closely within said receiving step and is contained by said perimeter flange;
and tab means for obstructing said frame panel from sliding out of said perimeter flange.

18. The apparatus of claim 16, additionally comprising an inner conversion border including a looped elongate member shaped and sized in perimeter to fit snugly within said frame panel, over said lens and over said image sheet.

19. The apparatus of claim 16, additionally comprising terminal wiring, a PC board and a battery charger and a battery charger outlet, wherein said electric power source comprises a battery connected to said terminal wiring and to said PC board, said PC board being contained within said battery compartment, and said wiring being connected to said battery charger outlet and said battery charger outlet being mounted in a port in said frame panel to face outwardly from said frame panel;
and a battery charger having means for plugging into said battery charger outlet and for plugging into a building wall outlet.

20. The apparatus of claim 6, wherein said light source comprises:
a bulb notch in an edge of said back panel,
a fluorescent light bulb fitted within said bulb notch, such that said fluorescent light bulb casts light into and through said back panel and forwardly through said image sheet.

21. The apparatus of claim 16, additionally comprising a motion sensor mounted to said frame housing and directed to sense motion generally forwardly of said apparatus, said motion sensor being integrated into said power circuit such that said light source is activated only when movement is sensed.

22. The apparatus of claim 21, additionally comprising a timer circuit element incorporated into said power circuit for shutting off power to said light source after a certain amount of time has passed since said motion sensor last detected motion.

23. The apparatus of claim 16, additionally comprising a table top stand including a block having a mounting notch in its upper surface for removably receiving an edge of said frame panel to hold said frame panel upright.

24. An apparatus for sequentially displaying several distinct and separate two-dimensional images, comprising:
a lenticular image sheet printed with a series of discrete elongate image segments of at least two images, said image segments being mutually parallel and laterally spaced apart in a repeating sequence comprising a segment of a first said image, and then a segment of a second said image;
a light source oriented to cast light through said image sheet;
a power source connected to said light source through a power circuit;
a lenticular lens comprising a sheet of transparent material having a lens surface embossed with an array of mutually parallel linear lens bulges corresponding in width and lateral spacing with the width and lateral spacing of said image segments;
and a frame housing retaining said image sheet and said lens in front of and substantially parallel with said image sheet, said frame housing having an open forward region through which said image sheet is visible through said lens;
such that said image segments for each given said image exclusively combine with each other through said lenticular lens to present exclusively each given image to an observer in front of said frame housing.

25. The apparatus of claim 24, additionally comprising means for causing relative movement between said lens and image sheet.

26. An apparatus for sequentially displaying several distinct and separate two-dimensional images, comprising:
an image sheet printed with a series of discrete elongate image segments of at least two images, said image segments being mutually parallel and laterally spaced apart in a repeating sequence comprising a segment of a first said image, and then a segment of a second said image;
a translucent back panel behind said image sheet;
a light source oriented to cast light through said back panel;
a power source connected to said light source through a power circuit;
an optical barrier comprising a sheet of transparent material having a optical barrier surface embossed with an array of mutually parallel linear optical barrier bulges corresponding in width and lateral spacing with the width and lateral spacing of said image segments;
and a frame housing retaining said image sheet and said optical barrier in front of and substantially parallel with said image sheet, said frame housing having an open forward region through which said image sheet is visible through said optical barrier;
such that said image segments for each given said image exclusively combine with each other through said optical barrier to present exclusively each given image to an observer in front of said frame housing.
